(19) United States
(12) Patent Application Publication
(10) Pub. No.: US 2004/0063059 A1
(43) Pub. Date: Apr. 1, 2004

(54) Dental braces and methods for coating

(76) Inventor: Nathan K. Meckel, La Mesa, CA (US)

Correspondence Address: NEIL K. NYDEGGER, NYDEGGER & ASSOCIATES, 348 OLIVE STREET, SAN DIEGO, CA, 92103, US

(21) Appl. No.: 10/262,583

(22) Filed: Sep. 30, 2002

(51) Int. Cl. A61C 3/00; B05D 3/00

(52) U.S. Cl. 433/8; 427/2.29

(57) ABSTRACT

Components of a dental brace including arch wires and brackets are coated with a hard, wear resistant material that has a low coefficient of friction. The aesthetically pleasing coating encapsulates the substrate material preventing the release of toxins from the substrate material that would otherwise occur due to wear, galling or corrosion. The coating includes a first layer of a metal which is preferably Titanium, Zirconium or Hafnium, a second layer that is preferably a Nitride of the metal used in the first layer and a third layer that is preferably a Nitride of the metal used in the first layer and has approximately two metal atoms for every Nitrogen atom. The coating is preferably applied using a physical vapor deposition source such as a cathodic arc source with a controlled gas atmosphere.

### FIELD OF THE INVENTION

The present invention pertains generally to coated dental braces and methods for coating dental braces. More particularly, the present invention pertains to dental braces that are coated with a hard, wear resistant coating. The present invention is particularly, but not exclusively, useful for brackets and arch wires for dental braces having a metal Nitride coating.

### BACKGROUND OF THE INVENTION

It is often necessary to use dental braces to correct the irregular positioning of teeth. Components of a dental brace typically include a plurality of brackets and an arch wire. In use, a bracket is bonded to each tooth on one or both jaws of the patient. The arch wire is then positioned in a slot of the bracket and tightened to selectively move the patient's teeth into their correct positions. The interaction between the arch wire and the bracket is sometimes referred to as “sliding mechanics.” Typically, the arch wire is tightened periodically (e.g. once every three to four weeks) to slowly move the teeth into their correct positions.

Tightening of the arch wire causes the arch wire to move relative to each bracket. This sliding contact between the arch wire and bracket can cause wear and galling at the contact surfaces of both the arch wire and bracket. The effects of wear and galling, in turn, can present a resistance to sliding that can interfere with the tightening process and lead to a nonuniform distribution of stresses in the arch wire that can adversely affect the correction procedure. Heretofore, brackets have been generally made of stainless steel. More recently, to avoid the Nickel and Chromium in stainless steel, brackets have been made of a Titanium alloy that is, however, relatively soft and susceptible to wear and galling at the contact surfaces. Accordingly, it would be desirable for the contact surfaces between the brackets and arch wire to have a low coefficient of friction that is maintained over the course of the correction procedure.

In addition to interfering with the sliding contact between the brackets and arch wire, wear and galling can result in the removal of material from the arch wire or brackets that can result in the unnecessary exposure of the patient to a hazardous material. For example, arch wires are typically made of either a stainless steel alloy containing Chromium and Nickel or a Titanium-Nickel alloy. These materials, especially Chromium and Nickel, are generally considered to be toxins, and may be carcinogenic, to which patient exposure should be avoided. Along these same lines, corrosion can result in the release of potentially toxic materials if the materials used to prepare the braces and arch wires are not corrosion resistant. Corrosion can also affect the aesthetics of the braces which is an important factor in the design of dental braces.

In light of the above, it is an object of the present invention to provide components for dental braces that are coated with a material that is hard, wear resistant, corrosion resistant, and has a low coefficient of friction. It is another object of the present invention to provide methods for coating components for dental braces with a hard, wear resistant, low-friction coating. It is yet another object of the present invention to provide a coating for dental brace components that is aesthetically pleasing and that encapsulates the component substrate material to prevent patient exposure to toxins and allergens in the substrate material.

### SUMMARY OF THE PREFERRED EMBODIMENTS

The present invention is directed to coated dental braces and methods for coating dental braces. Components of a dental brace including arch wires and brackets are coated with a coating material that is hard, wear resistant and has a relatively low coefficient of friction. By encapsulating the substrate material (i.e. the underlying material that the uncoated arch wires and brackets are made of) the coating prevents the release of substrate material into the patient's mouth that would otherwise occur in the absence of the coating due to wear, galling or corrosion.

For the present invention, the coating includes a first layer of a metal which is preferably Titanium, Zirconium or Hafnium. The first layer overlays and contacts a portion or all of the dental brace component and preferably overlays portions of the component that will be visible when the dental brace is worn. Importantly, the first layer overlays the portion of each component that contacts and interacts (i.e. wear surfaces) with other components. In one implementation of the present invention, the entire arch wire is coated and all portions of each bracket are coated except the surface of the bracket that is to be bonded to a tooth (hereinafter referred to as the bonding face).

The coating further includes a second layer that overlays and contacts the first layer. The second layer is preferably a Nitride of the metal used in the first layer. For example, for a coating having Titanium as the first layer, the second layer is preferably Titanium Nitride (TiN). Similarly, for a coating having Zirconium as the first layer, the second layer is preferably Zirconium Nitride (ZrN) and for a coating having Hafnium as the first layer, the second layer is preferably Hafnium Nitride (HfN). Note; the abbreviations (e.g. TiN, ZrN and HfN) are used herein as a shorthand rather than an exact chemical label, and do not suggest that the stoichiometry of the indicated compound must be exactly as stated in the abbreviation.

The coating further includes a third layer that overlays and contacts the second layer. For the present invention, the third layer is the top layer, constituting the material that is exposed and visible when the braces are worn. The third layer is preferably a Nitride of the metal used in the first layer and has approximately two metal atoms for every Nitrogen atom. For example, for a coating having Titanium as the first layer and Titanium Nitride (TiN) as the second layer, the third layer is preferably a so-called di-Titanium Nitride (TiₓN) wherein the Nitrogen level has been reduced to obtain a bright, lustrous, silver look. Similarly, for a coating having Zirconium as the first layer and Zirconium Nitride (ZrN) as the second layer, the third layer is preferably a so-called di-Zirconium Nitride (ZrₓN). Likewise, for a coating having Hafnium as the first layer and Hafnium Nitride (HfN) as the second layer, the third layer is preferably a so-called di-Hafnium Nitride (HfₓN).

In accordance with the present invention, the coating is preferably applied using a physical vapor deposition source such as a cathodic arc source with a controlled gas atmosphere. Other operable techniques such as magnetron sputtering may also be used. During coating deposition, the brackets and arch wires are held in fixtures and the fixtures are rotated in a planetary movement about a central axis. In greater detail, the brackets are held in a fixture that includes a plate that is formed with a plurality of relatively shallow slots. Each slot extends around the plate in a closed loop. A plurality of brackets are placed somewhat loosely in each slot with the bonding face of each bracket oriented face-down in the slot. The remainder of the bracket protrudes from the slot, thus exposing bracket surfaces other than the bonding surface to the vapor in the chamber. Accordingly, these exposed surfaces are coated while the bonding face remains uncoated. Because each slot is formed in a closed loop, brackets are prevented from ‘walking’ off the plate in spite of the fact that the brackets are subject to rotational movement and minor vibrations. The slotted plate separates the brackets and prevents the brackets from movement (i.e. tipping) into non-desirable orientations during coating.

The arch wires are held in a fixture that includes a pair of wire screens with each screen creating a plurality of apertures. The screens are aligned parallel to each other and spaced apart to allow the arch wires to hang from screen to screen. More specifically, a first end of each arch wire is inserted into a respective aperture of the first screen and the second end of each arch wire in inserted into a respective aperture of the second screen. This cooperation of structure allows a plurality of arch wires to be uniformly spaced from each other in the deposition chamber. Further, the screens function as an ionization diffuser as the arch wires are being coated.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the mouth of a patient wearing dental braces;

FIG. 2 is an enlarged, perspective view of a coated bracket for dental braces;

FIG. 3 is an enlarged cross-sectional view of a portion of the coated bracket shown in FIG. 2 as seen along line 3-3 in FIG. 2 showing the coating layers;

FIG. 4 is a perspective view of a fixture for supporting the brackets during the coating process;

FIG. 5 is a cross-sectional view as seen along line 5-5 in FIG. 4 showing a bracket positioned in a slot of the fixture;

FIG. 6 is a perspective view of a fixture for supporting arch wires during the coating process;

FIG. 7 is a schematic plan view and control diagram of a deposition apparatus for use in the invention;

FIG. 8 is a schematic perspective view of a detail of the deposition apparatus of FIG. 6; and

FIG. 9 is a schematic cross-sectional view of a preferred cathodic arc source, taken along lines 9-9 of FIG. 8.

### DESCRIPTION OF THE PREFERRED EMBODIMENT

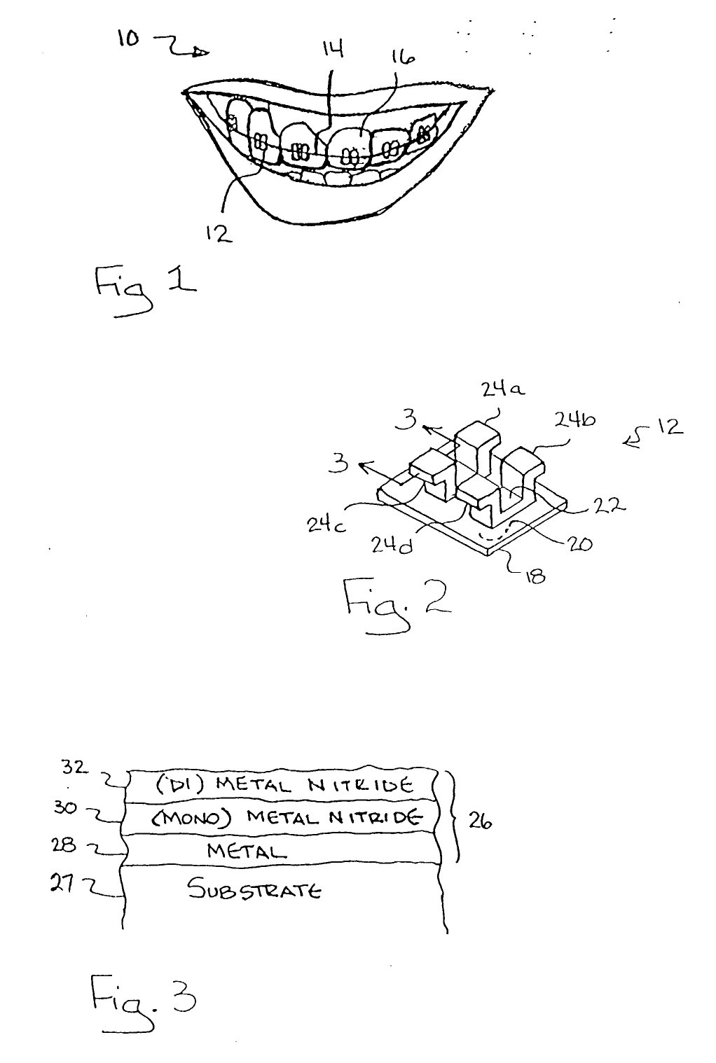

Referring to FIG. 1, dental braces are shown positioned on the teeth of a patient's upper jaw and generally designated 10. As shown in FIG. 1, the dental braces 10 include a plurality of brackets 12 and an arch wire 14. A bracket 12 is bonded to each tooth 16 on the patient's upper jaw and a ligating module (e.g. a rubber band) is used to attach the arch wire 14 to a respective bracket 12. The ends of the arch wire 14 can then be attached to buccal tubes (not shown) that are mounted on the patient's molars. The buccal tubes allow the arch wire 14 to be tightened by the orthodontist to selectively move the patient's teeth into their correct positions.

A better appreciation of a bracket 12 can be obtained with reference to FIG. 2. As shown, the bracket 12 includes a base 18 having a bonding face 20 that is bonded to the tooth 16. In some cases, a mesh (not shown) is interposed between the tooth 16 and the bonding face 20 to facilitate removal of the bracket 12 at the conclusion of the corrective procedure. As further shown in FIG. 2, the bracket 12 includes contact surfaces 22 which will be in sliding contact with the arch wire 14 during use (See FIG. 1). Also shown, four projections 24a-d extend from the base 18 allowing a ligating module to be wrapped around the projections 24a-d to secure the arch wire 14 to the bracket 12.

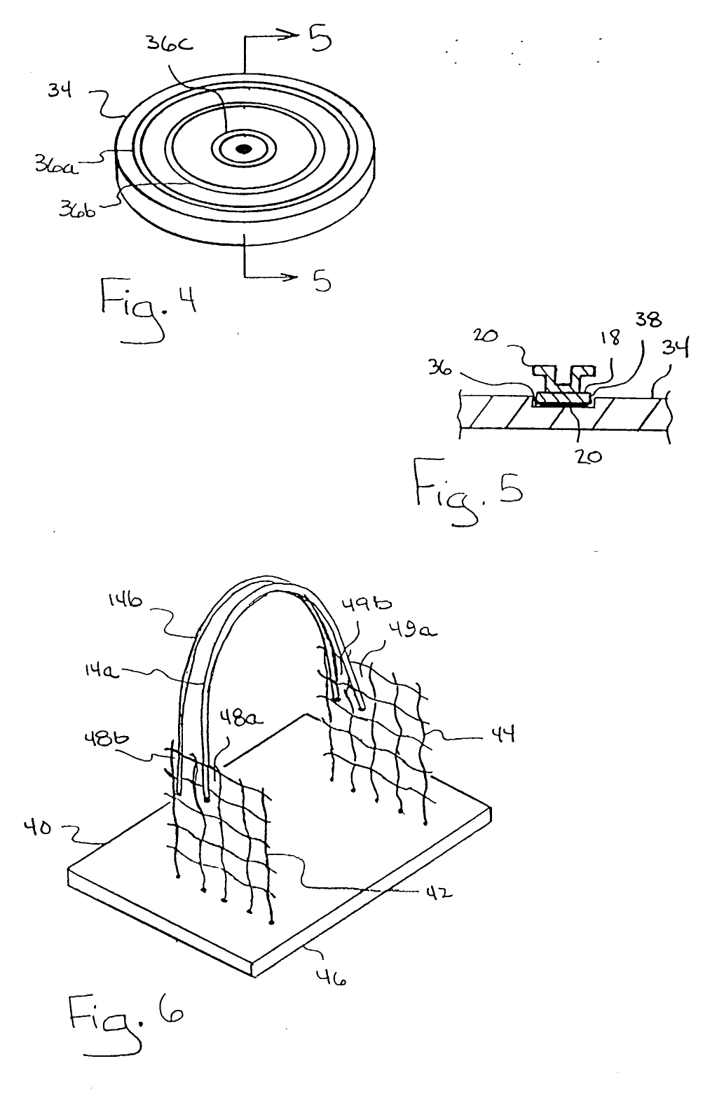

Referring now to FIG. 3, a coating 26 is shown applied to a substrate 27 that can be either the bracket 12 or the arch wire 14. In the case of the bracket 12, the substrate 27 is typically made of a corrosion resistant material such as a Titanium alloy or stainless steel. In the case of the arch wire 14, the substrate is typically made of stainless steel or a shape memory alloy such as a Nickel-Titanium alloy. In either case, as shown in FIG. 3, the coating 26 includes a first layer 28 of a metal which is preferably Titanium, Zirconium or Hafnium. The use of a metal for the first layer 28 ensures that the coating 26 adheres strongly to the substrate 27. The coating 26 preferably overlays and contacts portions of the bracket 12 that will be in sliding contact with the arch wire 14 (i.e. contact surfaces 22 shown in FIG. 2) and all other surfaces that will be visible when the dental brace 10 is worn. Accordingly, the coating 26 preferably overlays and contacts the entire arch wire 14.

Continuing with FIG. 3, it can be seen that the coating 26 further includes a second layer 30 that overlays and contacts the first layer 28. The second layer 30 is preferably a Nitride of the metal used in the first layer 28 having approximately one metal atom for each Nitrogen atom (i.e. a monometal Nitride). For example, for a coating 26 having Titanium as the first layer 28, the second layer 30 is preferably Titanium Nitride (TiN). Similarly, for a coating having Zirconium as the first layer 28, the second layer 30 is preferably Zirconium Nitride (ZrN) and for a coating having Hafnium as the first layer 28, the second layer 30 is preferably Hafnium Nitride (HfN). Note: as indicated above, the abbreviations (e.g. TiN, ZrN and HfN) are used herein as a shorthand rather than an exact chemical label, and do not suggest that the stoichiometry of the indicated compound must be exactly as stated in the abbreviation.

With continued reference to FIG. 3, it can be seen that the coating 26 further includes a third layer 32 that overlays and contacts the second layer 30. As shown, the third layer 32 is the top layer, constituting the material that is exposed and visible when the dental braces 10 are worn. The third layer 32 is preferably a Nitride of the metal used in the first layer 28 and has approximately two metal atoms for every Nitrogen atom (i.e. a di-metal Nitride). For example, for a coating 26 having Titanium as the first layer 28 and Titanium Nitride (TiN) as the second layer 30, the third layer 32 is preferably di-Titanium Nitride (TiₓN). Similarly, for a coating 26 having Zirconium as the first layer 28 and Zirconium Nitride (ZrN) as the second layer 30, the third layer 32 is preferably di-Zirconium Nitride (ZrₓN). Likewise, for a coating 26 having Hafnium as the first layer 28 and Hafnium Nitride (HfN) as the second layer 30, the third layer 32 is preferably di-Hafnium Nitride (HfₓN).

Referring now to FIG. 4, a fixture 34 is shown for holding the brackets 12 during coating. As shown, the fixture 34 is formed as a circularly shaped plate that is formed with a plurality of relatively shallow slots 36a-c with each slot 36a-c extending on the plate in a closed loop. As best seen in FIG. 5, brackets 12 are placed somewhat loosely in each slot 36 with the bonding face 20 of each bracket 12 oriented face-down in the slot 36. As shown, portions of the bracket 12 (except the bonding face 20 and the edges 38 of the base 18) protrude from the slot 36 leaving these portions exposed to receive coating 26. With the slot 36 formed as a closed loop, brackets 12 are prevented from ‘walking’ off the plate in spite of the fact that the brackets 12 are subject to rotational movement (see description below) and minor vibrations during coating. Also, the slots 36 separate the brackets 12 and prevent the brackets 12 from movement (i.e. tipping) into non-desirable orientations during coating.

Referring now to FIG. 6, a fixture 40 is shown for holding a plurality of arch wires during coating, for which two exemplary arch wires 14a and 14b have been shown for clarity. As shown, the fixture 40 includes a pair of wire screens 42, 44 that are mounted on a base 46. Wire screen 42 is formed with a plurality of apertures, for which exemplary apertures 48a and 48b have been labeled. Similarly, wire screen 44 is formed with a plurality of apertures, for which exemplary apertures 49a and 49b have been labeled. As further shown, the screens 42, 44 extend from the base 46 and are aligned substantially parallel to each other. The screens 42, 44 are spaced apart to allow the arch wires 14a, 14b to drape from screen 42 to screen 44. In one implementation, as shown, one end of arch wire 14a is inserted into aperture 48a of screen 42 and the second end is inserted into aperture 49a of screen 44. Similarly, one end of arch wire 14b is inserted into aperture 48b and the second end is inserted into aperture 49b. This cooperation of structure allows a plurality of arch wires 14 to be uniformly spaced from each other during coating. Although the exemplary screens 42, 44 shown are sized to hold about sixteen arch wires 14, it is to be appreciated that larger screens having more apertures could be used to hold arch wires 14 during coating.

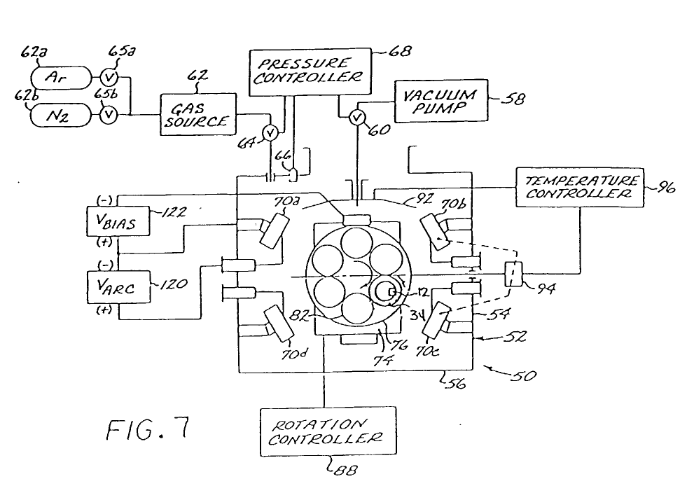

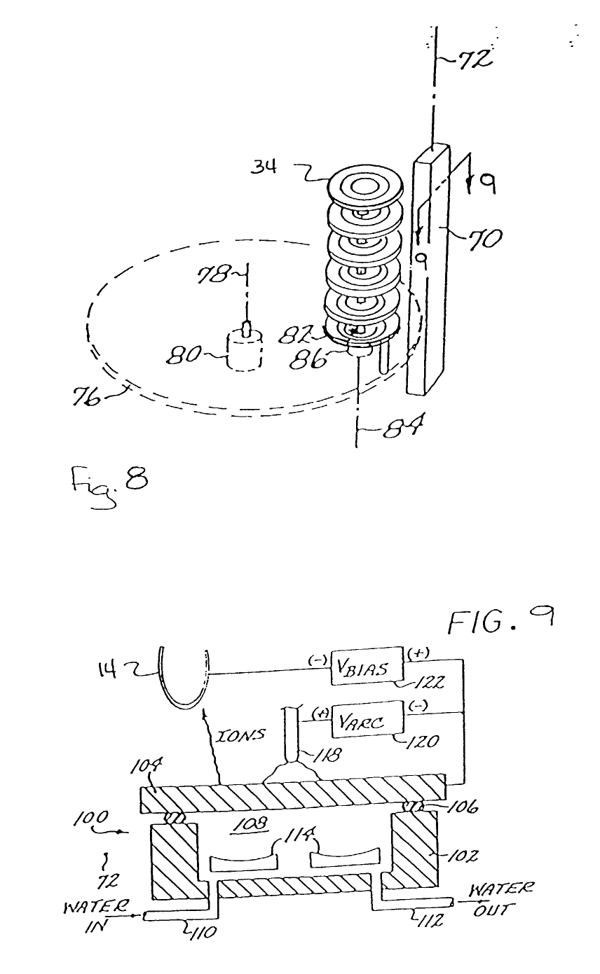

FIGS. 7 and 8 depict a preferred deposition apparatus 50 for coating the brackets 12 and arch wires 14 (not shown), although other operable deposition apparatus may be used. The deposition apparatus 50 includes a chamber 52 having a body 54 and a door 56 that may be opened for access to the interior of the chamber 52 and which is hermetically sealed to the body 54 when the chamber 52 is in operation. The interior of the chamber 52 is controllably evacuated by a vacuum pump 58 pumping through a gate valve 60. The vacuum pump 58 includes a mechanical pump and a diffusion pump operating together in the usual manner. The interior of the chamber 52 may be controllably backfilled to a partial pressure of a selected gas from a gas source 62 through a backfill valve 64. The gas source 62 typically includes several separately operable gas sources. The gas source 62 usually includes a source 62a of an inert gas such as argon and a source 62b of Nitrogen gas, each providing gas selectively and independently through a respective selector valve 65a or 65b. Other types of gas can also be provided as desired.

The pressure within the chamber 52 is monitored by a vacuum gage 66, whose output signal is provided to a pressure controller 68. The pressure controller 68 controls the settings of the gate valve 60 and the backfill valve 64 (and, optionally, the selector valves 65), achieving a balance of pumping and backfill gas flow that produces a desired pressure in the chamber 52 and thence pressure reading in the vacuum gage 66. Thus, the gaseous backfilled atmosphere within the chamber 52 is preferably a flowing or dynamic atmosphere.

At least two, and preferably four as shown, linear deposition sources 70 are mounted within the interior of the chamber 52 in a circumferentially spaced-apart manner. In FIG. 7, the four deposition sources are identified as distinct sources 70a, 70b, 70c, and 70d, as they will be addressed individually in the subsequent discussion. The four deposition sources 70 are generally rectangular bodies having a greatest rectilinear dimension elongated parallel to a source axis 72. This type of deposition source is distinct from either a stationary point source or a point source that moves along the length of the substrate 27 during deposition procedures.

A substrate support 74 is positioned in the chamber 52. The substrate support 74 produces a compound rotational movement of a fixture 34 (or fixture 40 if arch wires 14 are being coated) mounted thereon. The preferred substrate support 74 includes a rotational carriage 76 that rotates about an axis 78, driven by a rotational drive motor 80 below the rotational carriage 76. Mounted on the rotational carriage 76 are at least one and preferably six, as shown, planetary carriages 82. The planetary carriages 82 are rotationally driven about a rotational axis 84 by a planetary drive motor 86 below the planetary carriages 82. The speeds of the rotational drive motor 80 and the planetary drive motor 86 are controlled by a rotation controller 88. The rotation controller 88 preferably rotates the rotational carriage 76 at a rate of about 1 revolution per minute (rpm).

Continuing with FIGS. 7 and 8, for deposition processing of brackets 12, a plurality of fixtures 34 as described above can be stacked and mounted on the planetary carriage 82, as shown. For commercial operations, six to ten fixtures 34 having approximately 200-500 brackets 12 per fixture 34 are typically mounted on each planetary carriage 82 in the manner described, as illustrated for one of the planetary carriages 82 in FIG. 7. Alternatively, for deposition processing of arch wires 14 (not shown), one or more fixtures 40 as described above can be mounted on the planetary carriage 82. For commercial operations, a fixture 40 having approximately 100-350 arch wires 14 is typically mounted on each planetary carriage 82.

The temperature in the chamber 52 during deposition is controlled using a heater 92 that extends parallel to the deposition sources 70 on one side of the interior of the chamber 52. The heater 92 is preferably a radiant heater operating with electrical resistance elements. The temperature of the heating array is monitored by a temperature sensor 94 such as an infrared sensor that views the interior of the chamber 52. The temperature measured by the sensor 94 is provided to a temperature control circuit 96 that provides the power output to the heater 92. Acting in this feedback manner, the temperature controller 96 allows the temperature of the heating array to be set. In the preferred processing, the heating array is heated to a temperature of from about 1000° F. to about 1700° F.

FIG. 9 illustrates a cathodic arc source 100 used in the preferred form of the deposition source 70. The cathodic arc source 100 includes a channel-shaped body 102 and a deposition target 104. The deposition target 104 is in the form of a plate that is hermetically sealed to the body 102 using an 0-ring 106, forming a water-tight and gas-tight hollow interior 108. The interior 108 is cooled with cooling water flowing through a water inlet 110 and a water outlet 112. Two spirally shaped (only sections of the spirals are seen in FIG. 9) permanent magnets 114 extend parallel to the source axis 72. Positioned above the deposition target 104 exterior to the body 102 is a striker electrode 118. A voltage V_{ARC} is applied between the striker electrode 118 and the deposition target 104 by an arc source power supply 120. V_{ARC} is preferably from about 10 to about 50 volts.

The metallic material that initially forms the deposition target 104 is deposited onto the substrate, in this case an arch wire 14, together with, if desired, gas atoms producing gaseous species from the atmosphere of the chamber 52. In the preferred embodiment, the deposition target 104 is made of Zirconium (Zr) or Titanium (Ti) or Hafnium (Hf).

To accomplish the deposition, an arc is struck between the striker electrode 118 and the deposition target 104, locally heating the deposition target 104 and causing Zirconium, Hafnium or Titanium atoms and/or ions to be ejected from the deposition target 104. (The deposition target 104 is therefore gradually thinned as the deposition proceeds.) The striking point of the arc on the deposition target 104 moves in a racetrack course along the length of the deposition target 104. A negative bias voltage V_{BIAS} is applied between the deposition target 104 and substrate 27 (i.e. the bracket 12 or arch wire 14) by a bias power supply 122, so that any positively charged ions are accelerated toward the substrate 27.

V_{BIAS} is preferably from about −30 to about −600 volts. The value selected for V_{BIAS} determines the energy of ionic impact against the surface of the substrates, a phenomenon termed ion peening. In a typical case, V_{BIAS} is initially selected to be a relatively large negative voltage to achieve good adherence of the metallic first layer 28 (see FIG. 3) to the bracket 12 or arch wire 14. V_{BIAS} is subsequently reduced (made less negative) when overlying hard layers are deposited, to achieve a uniform, fine microstructure in the layers. The values of V_{BIAS} are desirably maintained as low as possible, consistent with obtaining an adherent coating 26. V_{BIAS} is more positive than −600 volts, and most preferably more positive than −400 volts. If V_{BIAS} is too negative, corona effects and backsputtering may occur at some regions of the bracket 12 or arch wire 14. Thus, while higher V_{BIAS} voltages may be used in some instances, generally it is preferred that V_{BIAS} be more positive than −600 volts. The cathodic arc source 100 is preferred, but other types of sources, such as sputtering sources, may also be used.

The cooperative selection of the material of the deposition target 104 and the gases introduced into the deposition chamber 52 from the gas source 62 allows a variety of coatings 26 to be deposited onto the bracket 12 or arch wire 14, within the constraints discussed previously. In the case of brackets 12, the thickness of the coating 26 is preferably from about 1 to about 10 micrometers. On the other hand, in the case of an arch wire 14, the thickness of the coating 26 is preferably from about 0.25-5 micrometers. If the coating thickness is less than about 1 micrometer, the physical properties of the coating 26 are insufficient to produce the desired results. If the coating thickness is more than about 10 micrometers, the coating 26 has a high internal stress that leads to a tendency for the coating 26 to crack and spall away from the bracket 12 or arch wire 14 during deposition or during service.

These general principles are applied in preparing the coatings 26 of interest, as described previously in relation to FIG. 3. The coating 26 of FIG. 3 includes a metallic first layer 28, such as metallic Zirconium, Hafnium or Titanium, that contacts and overlays surface of the bracket 12 or arch wire 14. The metallic first layer 28 aids in adhering the overlying layer(s) to the surface of the substrate. The metallic first layer 28 is preferably quite thin, on the order of from about 100 Angstroms to about 1000 Angstroms thick. The metallic first layer 28 is deposited by backfilling the deposition chamber 52 with a small partial pressure of about 5 microns of an inert gas, such as flowing argon (flowing at a rate of about 200-450 standard cubic centimeters per minute (sccm) in the apparatus used by the inventors), and then depositing metal, such as Zirconium, Hafnium or Titanium, from the deposition target 104 with V_{BIAS} about −400 volts. Because the argon does not chemically react with the metal, a metallic first layer 28 is deposited.

As shown in FIG. 3, a second layer 30, which is a metal Nitride having approximately one metal atom per atom of Nitrogen, overlies the metallic first layer 28. The second layer 30 is deposited by backfilling the deposition chamber 52 with a small partial pressure of about 5 microns of flowing Nitrogen (flowing at a rate of about 150-500 seen in the inventors' apparatus), and then depositing metal, such as Zirconium, Hafnium or Titanium, from the deposition target 104 with V_{BIAS} about −50 volts. The metal combines with the Nitrogen to produce the metal Nitride in the second layer 30. The second layer 30 is preferably of a thickness of approximately 0.25 to 5 micrometers.

Also shown in FIG. 3, a third layer 32, which is a metal Nitride having approximately two metal atoms per atom of Nitrogen, overlies the second layer 30. The third layer 32 is deposited by backfilling the deposition chamber 52 with a small partial pressure of about 5 microns of flowing Nitrogen (flowing at a rate of about 150-500 seen in the inventors' apparatus), and then depositing metal, such as Zirconium, Hafnium or Titanium, from the deposition target 104 with V_{BIAS} about −50 volts. The metal combines with the Nitrogen to produce the metal Nitride in the third layer 32. The third layer 32 is preferably of a thickness of approximately 0.25-5 micrometers with the total thickness of the coating 26 being from about 1 to about 10 micrometers.

While the particular dental braces and methods for coating as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A coated component for a dental brace, said coated component comprising:
a component substrate; and
a coating overlying at least a portion of said component substrate, said coating comprising a Nitride of a metal selected from the group of metals consisting of Titanium, Zirconium and Hafnium.

2. A coated component as recited in claim 1 wherein said component substrate is a bracket.

3. A coated component as recited in claim 1 wherein said component substrate is an arch wire.

4. A coated component as recited in claim 1 wherein said Nitride is di-Titanium Nitride (TiₓN).

5. A coated component as recited in claim 1 wherein said Nitride is di-Zirconium Nitride (ZrₓN).

6. A coated component as recited in claim 1 wherein said Nitride is di-Hafnium Nitride (HfₓN).

7. A coated component as recited in claim 1 wherein said coating comprises a layer of a metal overlying and contacting said portion of said component substrate, said metal selected from the group of metals consisting of Titanium, Zirconium and Hafnium.

8. A coated component as recited in claim 1 wherein said coating comprises a first layer of Titanium overlying and contacting said component substrate, a second layer of Titanium Nitride overlying and contacting said first layer and a third layer of di-Titanium Nitride overlying and contacting said second layer.

9. A method for manufacturing a coated component for a dental brace, said method comprising the steps of:
providing a component substrate; and
coating at least a portion of said component substrate with a Nitride of a metal selected from the group of metals consisting of Titanium, Zirconium and Hafnium.

10. A method as recited in 9 wherein said coating step includes the steps of:
providing a deposition apparatus comprising at least two linear deposition sources with each said deposition source lying parallel to an axis and each said deposition source being a source of said metal, a Nitrogen source and a fixture;
engaging said component with said fixture;
rotating said fixture in a planetary movement about said axis; and
operating said deposition sources to deposit said Nitride onto said component, the steps of rotating, and operating to occur simultaneously.

11. A method as recited in claim 10 wherein each said linear deposition source is a cathodic arc source.

12. A method as recited in claim 10 wherein said component is a bracket and said fixture comprises a plate formed with at least one slot for holding said bracket during said steps of rotating and operating.

13. A method as recited in claim 10 wherein said plate is formed with a plurality of slots with each said slot formed as a closed loop to hold a plurality of said brackets during said steps of rotating and operating.

14. A method as recited in claim 10 wherein said component is an arch wire and said fixture comprises a pair of spaced apart screens for holding said arch wire during said steps of rotating and operating.

15. An orthodontic brace comprising:
a plurality of brackets, at least a portion of each said bracket being coated with a coating material comprising a Nitride of a metal selected from the group of metals consisting of Titanium, Zirconium and Hafnium; and
an arch wire, at least a portion of said arch wire being coated with said coating material.

16. An orthodontic brace as recited in claim 15 wherein said Nitride is di-Titanium Nitride (TiₓN).

17. An orthodontic brace as recited in claim 15 wherein said Nitride is di-Zirconium Nitride (ZrₓN).

18. An orthodontic brace as recited in claim 15 wherein said Nitride is di-Hafnium Nitride (HfₓN).

19. An orthodontic brace as recited in claim 15 wherein said coating material comprises a layer of a metal.

20. A coated component as recited in claim 15 wherein said coating comprises a layer of Titanium, a layer of Titanium Nitride and a layer of di-Titanium Nitride.
